(19) United States
(12) Patent Application Publication
(10) Pub. No.: US 2024/0218239 A1
(43) Pub. Date: Jul. 4, 2024

(54) CALCIUM SULFATE SCALE CONTROL FOR DISPOSAL WELLS

(71) Applicant: Saudi Arabian Oil Company, Dhahran (SA)

(72) Inventors: Qiwei Wang, Dhahran (SA); Tao Chen, Dhahran (SA)

(21) Appl. No.: 18/092,703

(22) Filed: Jan. 3, 2023

(51) Int. Cl. C09K 8/532; C02F 5/08

(52) U.S. Cl. CPC C09K 8/532; C02F 5/08; C02F 2103/06; C02F 2303/22

(57) ABSTRACT

This disclosure relates to methods for reducing or preventing the formation of calcium sulfate scaling in disposal wells by treating produced water with water-soluble barium salts.

### TECHNICAL FIELD

This disclosure describes methods of reducing or preventing the formation of calcium sulfate (gypsum) scale in wells used in oil and gas production, such as in disposal or injection wells. Also described are methods for reducing the sulfate concentration in water produced during oil and gas recovery operations.

### BACKGROUND

Large quantities of water are produced during oil and gas recovery. For inland productions, the produced water is often injected underground for disposal (via disposal wells) after separation from the produced hydrocarbons. If the produced water can form inorganic scale precipitates under the disposal wells conditions, these precipitates can cause significant decline of injectivity and, in the worst cases, the abandonment of disposal wells. For produced waters that are supersaturated with calcium sulfate, formation of gypsum precipitates can quickly plug the disposal well and lead to loss of injectivity. Unlike other types of scale, calcium sulfate can form in large quantities within a short period of time, and once formed, is difficult to remove.

The use of threshold inhibitors to prevent scale deposition in surface facilities has been less successful when used for treating disposal wells. This is typically due to the applied scale inhibitor being retained by rocks and therefore not traveling with the disposed water in the wells, resulting in water that is under-treated or untreated. Depending on the amount and location of the deposited calcium sulfate scale, periodic stimulation is required to restore the well injectivity, or a new disposal well is needed.

Thus, there is a need for a method for protecting disposal wells from calcium sulfate scaling that is easy to deploy, lowers treatment costs, and reduces scale inhibitor consumption.

### SUMMARY

Provided in the present disclosure is a method for reducing or preventing mineral scale formation in a well. In some embodiments, the method includes treating a water source supersaturated with calcium sulfate with a water-soluble barium salt, where the water-soluble barium salt reacts with the calcium sulfate to form a barium sulfate solid in the treated water source; providing the treated water source to a well; and reducing or preventing mineral scale formation in the well.

In some embodiments of the method, the water-soluble barium salt is selected from the group consisting of barium acetate, barium chloride, barium cyanide, barium hydroxide, and barium oxide. In some embodiments, the water-soluble barium salt is barium chloride.

In some embodiments of the method, the water source comprises fresh water, pond water, sea water, produced water, tower water, or a combination thereof, and is used in oil and gas recovery operations. In some embodiments, the water source is produced water.

In some embodiments of the method, the well is a disposal well.

In some embodiments of the method, the water source supersaturated with calcium sulfate comprises a sulfate concentration that is greater than the equilibrium sulfate concentration.

In some embodiments of the method, the treated water source comprises a sulfate concentration that is lower than the equilibrium sulfate concentration.

In some embodiments of the method, the amount of water-soluble barium salt is sufficient to yield a barium concentration that is at least about 50% higher than the sulfate concentration in the water source. In some embodiments, the amount of water-soluble barium salt added to the water source supersaturated with calcium sulfate is about 50% greater than the amount of sulfate in the water source.

In some embodiments of the method, the barium sulfate solid is removed from the treated water source prior to providing the treated water source to the well. In some embodiments, the barium sulfate solid is removed by gravitational sedimentation, medium filtration, bag filtration, a centrifugal separator, or a cyclone separator.

In some embodiments of the method, the water source supersaturated with calcium sulfate comprises a scale inhibitor.

In some embodiments of the method, the treated water source is mixed with an untreated water source supersaturated with calcium sulfate prior to providing the treated water source to the well, wherein the mixture comprises a sulfate concentration that is lower than the equilibrium sulfate concentration.

Also provided in the present disclosure is a method for decreasing the sulfate concentration in water produced during oil and gas recovery. In some embodiments, the method includes treating the produced water with a water-soluble barium salt, where the produced water is supersaturated with calcium sulfate; reacting the calcium sulfate with the water-soluble barium salt to form a barium sulfate solid; and removing the barium sulfate solid from the treated water, wherein the treated water is undersaturated in calcium sulfate after removal of the barium sulfate solid.

In some embodiments of the method, the water-soluble barium salt is selected from the group consisting of barium acetate, barium chloride, barium cyanide, barium hydroxide, and barium oxide. In some embodiments, the water-soluble barium salt is barium chloride.

In some embodiments of the method, the barium sulfate solid is removed by gravitational sedimentation, medium filtration, bag filtration, a centrifugal separator, or a cyclone separator.

In some embodiments, the method further includes providing the water undersaturated in calcium sulfate to a well. In some embodiments, the well is a disposal well.

In some embodiments of the method, the produced water comprises a scale inhibitor.

### DESCRIPTION OF DRAWINGS

FIG. 1 is a graph showing the change of gypsum supersaturation ratio SR in a mixture of calcium-rich water and sulfate-rich water, where SR<1 is undersaturated; SR=1 is in equilibrium, and SR>1 is supersaturated and the water has tendency to form scale.

FIG. 2 is a graph showing the predicted gypsum scaling amount (mass) in a mixture of calcium-rich water and sulfate-rich water.

FIG. 3 shows the calcium sulfate scale form in the oilfield (temperature <100° C.).

FIG. 4 shows the scale inhibitor profile inside of a disposal well.

FIG. 5 is a flowchart showing the path of produced water from oil wells during oil and gas recovery.

FIG. 6 is an illustration showing calcium sulfate scale formation inside of a disposal well.

FIGS. 7A-7C shows the results of precipitation tests before addition (FIG. 7A), immediately after addition (FIG. 7B), and 4 hours after addition (FIG. 7C) of barium chloride to water samples.

FIG. 8 is a graph showing the change in sulfate concentration over time in water treated with barium chloride.

FIG. 9 is a graph showing critical (equilibrium) sulfate concentration at various temperatures and pressures, where the water has no potential to form calcium sulfate scale once the sulfate is reduced below these concentrations.

FIG. 10 is a flow chart showing a method of treating produced water to reduce sulfate concentration.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Provided in the present disclosure are methods of protecting wells by reducing or preventing the formation of mineral scale. The methods utilize the low solubility behavior of barium sulfate to remove dissolved sulfate in water, such as water produced during oil and gas recovery. Without wishing to be bound by any particular theory, it is believed that by adding soluble salts of barium, such as chloride salts, to the water prior to disposal, dissolved sulfate in the water reacts with the added barium cations to form barium sulfate solids. Barium sulfate has much lower solubility than calcium sulfate in water. At room temperature, 1 liter of water dissolves 2.2 mg of barium sulfate (BaSO₄), but can dissolve, for example, 2090 mg of calcium sulfate in the form of anhydrite (CaSO₄) or 2410 mg in form of gypsum (CaSO₄•2H₂O). The barium sulfate solids that form precipitate out of water as barium sulfate. Thus, sulfate concentration in the water is reduced and the treated water become much less supersaturated and less susceptible to scale, such as calcium sulfate scale. With enough sulfate removed, the water will become undersaturated and the potential for scale formation in wells is substantially reduced or eliminated.

The methods of the present disclosure can be used to effectively and permanently eliminate the potential for mineral scaling. In some embodiments, the methods reduce the consumption of scale inhibitor. The methods of the present disclosure therefore can lower treatment costs, both capital expenses (CAPEX) and operating expenses (OPEX). The methods of the present disclosure are also easy to deploy and are flexible in their application.

A primary source of scale in oil and gas operations is from mixing incompatible waters. Waters are “incompatible” if they interact chemically and precipitate minerals when mixed. In some embodiments, the two types of waters, for example, incompatible waters, are produced in the same field from different reservoirs. For example, the two waters can be from two oil-bearing carbonate reservoirs in the same field where one type of water is produced from a deeper reservoir than the second type of water. Typical examples of incompatible waters are waters containing sea water, such as water from reservoirs flooded using sea water, and formation waters, such as water from a carbonate reservoir. The sea water is typically “sulfate-rich,” having a high concentration of SO₄²⁻, while the formation water has high concentrations of ions such as Ca²⁺, Ba²⁺, and Sr²⁺. For example, the formation water can be “calcium-rich.” Mixing of the two types of water can cause precipitation of the salts formed by reacting the sulfate ions from the sea water with the ions from the formation water.

Supersaturation is a main reason behind mineral precipitation and is the primary cause of scale formation. It occurs when a solution contains dissolved materials which are at higher concentrations than their equilibrium concentration. The degree of supersaturation, also known as the scaling index, is the primary reason for precipitation. Changes in temperature, pressure, and pH, for example, can also contribute to scale formation.

Once water from different sources is comingled or combined, such as in a trunkline or in a gas/oil-water separation plant (GOSP), the mixed water becomes supersaturated with respect to the sulfate salt and can lead to the formation of scale. For example, the mixed water can be supersaturated with calcium sulfate, which can lead to the formation of gypsum scale. FIG. 5 is a flow chart depicting an exemplary process where water from three different oil wells is combined in the trunkline, which then enters the GOSP before injection in a disposal well. The methods of the present disclosure involve treating the combined water prior to injection in a disposal well. Thus, in some embodiments, the water is treated in the trunkline. In some embodiments, the water is treated in the GOSP.

Thus, provided in the present disclosure is a method for reducing or preventing mineral scale formation in a well. The methods can be used to reduce or prevent any type of mineral scale formation that is typical in aqueous systems where the systems are saturated with scaling ions or the concentrations of the scaling ions are raised to exceed the solubility for a particular salt at operating conditions. In some embodiments, the mineral scale is calcium sulfate scale. In some embodiments, the method includes treating a water source supersaturated with a sulfate salt with a water-soluble barium salt. In some embodiments, the sulfate salt is calcium sulfate.

Any water-soluble barium salt can be used in the methods of the present disclosure. In some embodiments, the water-soluble barium salt is selected from the group consisting of barium acetate, barium chloride, barium cyanide, barium hydroxide, and barium oxide. In some embodiments, the water-soluble barium salt is barium chloride. In some embodiments, the water-soluble barium salt is added in solid powder form. In some embodiments, the water-soluble barium salt is added as a concentrated solution.

The amount of water-soluble barium salt that is added to the water source that is supersaturated with a sulfate salt is an amount sufficient to yield a barium concentration that is at least about 50% higher than the sulfate concentration in the water source. In some embodiments, the amount of water-soluble barium salt added to the water source is at least about 50%, such as at least about 55%, about 60%, about 65%, about 70%, about 75%, about 80%, about 85%, about 90%, about 95%, about 99%, or about 100% higher than the sulfate concentration in the water source. For example, if the sulfate concentration is about 2000 mg/L, then about 3000 mg/L barium is added.

In some embodiments of the method, the water-soluble barium salt reacts with the sulfate salt to form a barium sulfate solid in the treated water source. In some embodiments, the sulfate salt is calcium sulfate. In some embodiments, the water-soluble barium salt is barium chloride. In some embodiments, barium chloride reacts with calcium sulfate to form a barium sulfate solid.

In some embodiments, the method includes providing the treated water source that contains the barium sulfate solid to a well. In some embodiments, the well is a disposal well or injection well. In some embodiments, the method reduces or prevents mineral scale formation in the well. For example, by reducing sulfate concentration in the treated water below a critical value (the equilibrium concentration), the treated water becomes undersaturated to gypsum under the disposal well conditions, thus the tendency for calcium sulfate scaling is eliminated.

In some embodiments of the methods, the water source comprises fresh water, pond water, sea water, produced water, tower water, or a combination thereof, and is used in oil and gas recovery operations. In some embodiments, the water source is produced water.

In some embodiments of the method, the water source is supersaturated with calcium sulfate. A water source that is supersaturated with calcium sulfate contains a sulfate concentration that is greater than the equilibrium sulfate concentration. In some embodiments, the water that has been treated with the water-soluble barium salt is undersaturated with calcium sulfate. Water that is undersaturated with calcium sulfate contains a sulfate concentration that is lower than the equilibrium sulfate concentration. The equilibrium sulfate concentration can be calculated using the sale prediction model, such as ScaleSoftPitzer™, using disposal well temperature and pressure conditions. The equilibrium sulfate concentration will vary depending on the exact temperature and pressure and composition of the water. Water that is supersaturated with calcium sulfate can form scale, whereas water that is undersaturated with calcium sulfate will not form scale. In some embodiments, with sufficient amount of barium added to the water, sulfate concentration is reduced to levels lower than 50 mg/L. The amount of sulfate removed can vary. For example, the amount of sulfate removed depends upon the type of water-soluble barium salt added and the amount added.

In some embodiments, the method involves removing the barium sulfate solid from the treated water source. Any method of removing the solid from the water can be used, including, but not limited to by gravitational sedimentation, medium filtration, bag filtration, a centrifugal separator, or a cyclone separator. In some embodiments, the high density of precipitated barium sulfate is beneficial when centrifuge, cyclone, or gravity separation is used. The density of barium sulfate is 4.50 g/cm³, which is much higher than sand, clays, calcium sulfate, or limestone particles (<3.0 g/cm³).

In some embodiments, the barium sulfate solid is removed from the treated water source prior to providing the treated water source to the well. For example, the barium sulfate solid can be removed after being in the trunkline or GOSP, but before injection into the well. In some embodiments, the barium sulfate solid is removed prior to injecting the water into the disposal or injection well.

Also provided in the present disclosure is a method for decreasing the sulfate concentration in water produced during oil and gas recovery. In some embodiments, the produced water is supersaturated with calcium sulfate. In some embodiments, the method includes treating the produced water with a water-soluble barium salt. In some embodiments, the water-soluble barium salt is selected from the group consisting of barium acetate, barium chloride, barium cyanide, barium hydroxide, and barium oxide. In some embodiments, the water-soluble barium salt is barium chloride.

In some embodiments, the method includes reacting the calcium sulfate with the water-soluble barium salt to form a barium sulfate solid.

In some embodiments, the method includes removing the barium sulfate solid from the treated water, where the treated water is undersaturated in calcium sulfate after removal of the barium sulfate solid. The barium sulfate solid can be removed using the methods described in the present disclosure. In some embodiments, the barium sulfate solid is removed by gravitational sedimentation, medium filtration, bag filtration, a centrifugal separator, or a cyclone separator.

In some embodiments, the method further includes providing the water undersaturated in calcium sulfate to a well. In some embodiments, the well is a disposal well.

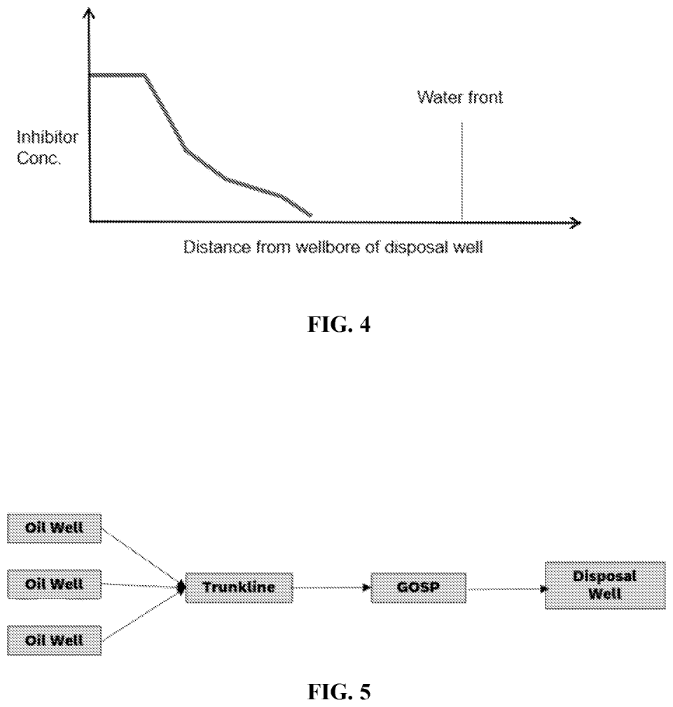

The methods of the present disclosure can be used in combination with scale or threshold inhibitors. Scale inhibitors are chemicals, such as water-soluble inorganic and organic compounds, which, when added in small amounts into the water system, reduce or prevent scale from forming. Scale inhibitors generally contain functional groups that are capable of bonding with the scaling cations, thereby keeping them in the aqueous solution. However, when water is injected into a disposal well, the scale inhibitor will also react with rocks and a portion of the inhibitor will be 10 retained on the rock surface. Thus, the inhibitor concentration will gradually decrease as the water travels in the pore space of disposal wells, reducing the efficacy of the scale inhibitor and resulting in scale formation (see, e.g., FIG. 4). The methods of the present disclosure avoid the problems associated with the use of scale inhibitors, as the reaction between the water-soluble barium salt and the sulfate salt occurs immediately; thus, dilution is not a concern. The presence of one or more scale inhibitors has no or minimal effect on sulfate reduction provided by the methods of the present disclosure.

Thus, in some embodiments of the method, the water source that is supersaturated with a sulfate salt contains a scale inhibitor. The methods of the present disclosure can be used in the presence of any scale inhibitor, such as inorganic phosphates, organophosphorous compounds, polycarboxylate compounds, and organic polymers, including, but not limited to aminotrimethylene phosphonic acid (ATMP), ethylenediaminetetramethylene phosphonic acid (EDTMP), diethylenetriaminepentamethylene phosphonic acid (DETPMP), bis(hexamethylene) triaminepenta(methylene phosphonic acid) (BHMT), pentaethylenehexamineoctakismethylene phosphonic acid (PEHOMP), 1-hydroxyethylidene-1,1-diphosphonic acid (HEDP), phosphino-carboxylic acids (PCA) homopolymaleic acid, poly(maleic-co-acrylic) acid, polyaspartic acid, and polyepoxysuccinic acid. In some embodiments, the scale inhibitor is SCALETREAT 16298, a polymeric inhibitor based on 2-butanedioic acid (2Z)-polymer with sodium 2-propene-1-sulfonate (Clariant). In some embodiments, the scale inhibitor is SCW 22127, a phosphonate product formulated with diethylenetriamine penta(methylene phosphonic acid) (Baker Hughes).

In some embodiments, the method includes treating one volume of water with the water-soluble barium salt to reduce the sulfate concentration to an amount that is lower than the equilibrium sulfate concentration prior to providing or injecting the treated water to the well, such as the disposal or injection well. In some embodiments, the amount of barium sulfate is calculated based on the equilibrium sulfate concentration.

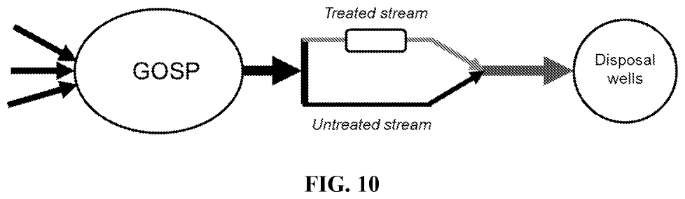

In some embodiments, the method includes treating one volume of water with the water-soluble barium salt to reduce the sulfate concentration to an amount that is lower than the equilibrium sulfate concentration, followed by mixing the treated water with a second volume of water that has not been treated. For example, in instances when the water flow rate is high, it can be more economical to treat a side-stream in order to achieve a very low sulfate concentration, then mixing with the untreated stream (see, e.g., FIG. 10). For example, to achieve a desired sulfate concentration, a first volume of water can be treated to have sulfate reduced to a low sulfate concentration, then mixed with a second volume of untreated scaling water with a higher sulfate concentration, to get a final sulfate concentration that is lower than the equilibrium sulfate concentration. When this mixed water in injected into the disposal wells, it is undersaturated with gypsum (calcium sulfate), and therefore, no gypsum scale will be formed in the disposal well reservoir. Thus, in some embodiments of the method, the treated water source is mixed with an untreated water source supersaturated with calcium sulfate prior to providing the treated water source to the well, wherein the mixture comprises a sulfate concentration that is lower than the equilibrium sulfate concentration.

The methods of the present disclosure can be used under disposal well conditions, such as at temperatures of about 100° F. to about 300° F. and pressures of about 1000 psi to about 5000 psi.

Thus, the methods of the present disclosure result in water having a greater amount of scale removed or prevented from forming as compared to the same water that is untreated or has been treated with a scale inhibitor, such as the scale inhibitors described in the present disclosure.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### EXAMPLES

### Example 1—Prediction Results for Gypsum Scale in Calcium- and Sulfate-Rich Waters

Calcium sulfate scale is usually formed due to mixing of incompatible waters, such as waters containing high calcium (such as calcium-rich formation water in carbonate reservoirs) and waters containing high sulfate (such as sulfate-rich produced water from reservoirs flooded using seawater). Once comingled in a trunkline or in a gas/oil-water separation plant (GOSP), the mixed water becomes supersaturated with respect to calcium sulfate and leads to the formation of gypsum scale.

The scaling tendency of water supersatured with calcium sulfate was simulated with thermodynamic prediction models. The ScaleSoftPitzer model (Brine Chemistry Consortium, Rice University) for gypsum scale (158ºF, 500 psi) was used to predict gypsum scaling in a mixture of two types of waters produced from two oil-bearing carbonate reservoirs in a single field in the Middle East. Water A is calcium-rich and produced from a deeper reservoir than Water B, which is sulfate-rich (Table 1).

TABLE 1
Calcium- and sulfate-rich waters produced
from two reservoirs in the same field

| (mg/L) | Water A | Water B |
|---|---|---|
| Sodium | 31915 | 32000 |
| Potassium | 1919 | 2761 |
| Magnesium | 5719 | 2368 |
| Calcium | 32666 | 2580 |
| Strontium | 1181 | 134 |
| Bicarbonate | 317 | 535 |
| Chloride | 126000 | 60559 |
| Sulfate | 540 | 3276 |
| pH | 5.2 | 6.9 |

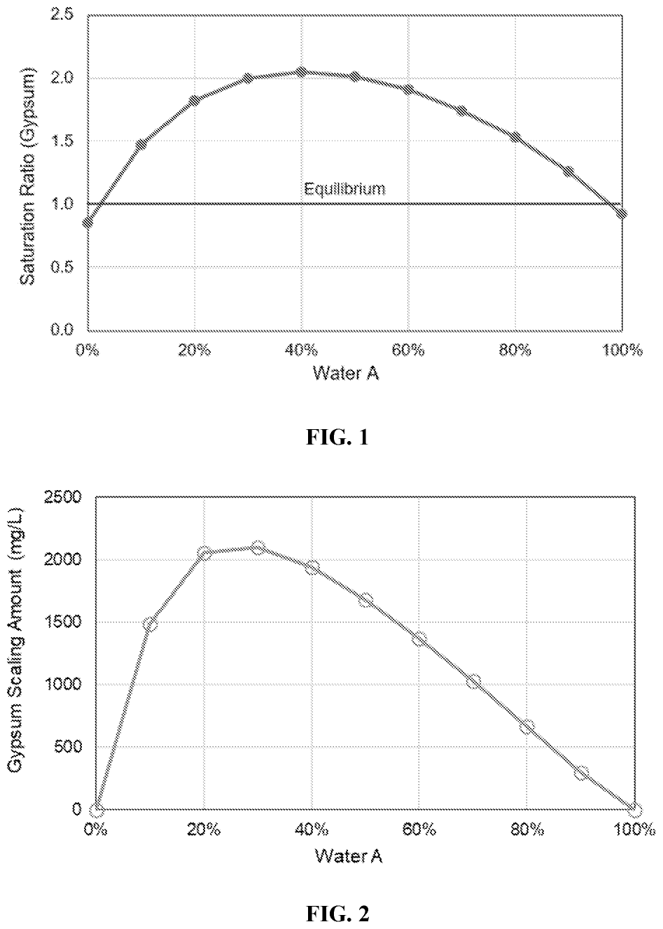

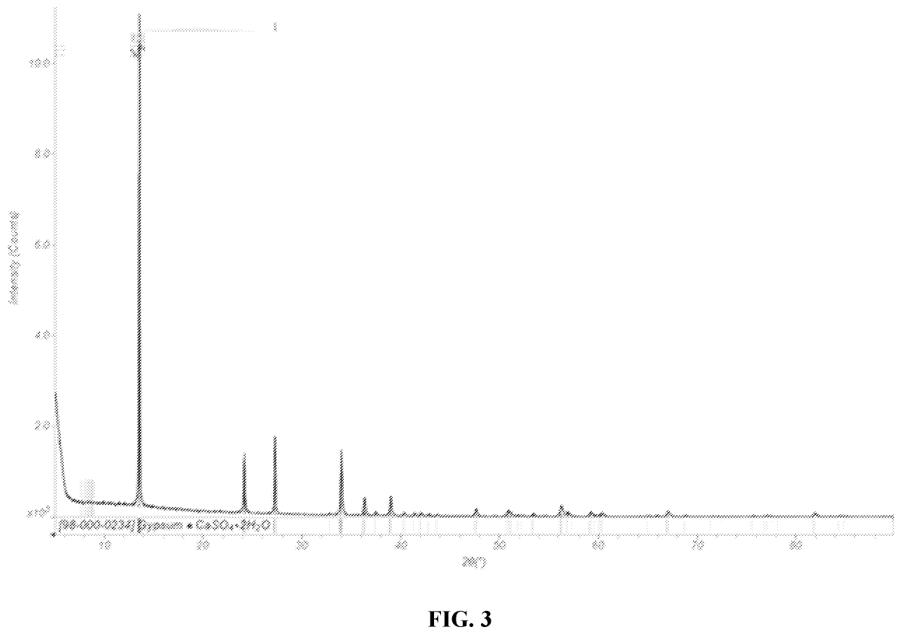

FIG. 1 and FIG. 2 and Table 2 show the prediction results for gypsum scale in a mixture of Water A and Water B at varying ratios of Water A to Water B. FIG. 1 shows the change in the gypsum supersaturation ratio (SR) with increasing amounts of Water A in the mixture. FIG. 2 shows the predicted amount (mass) of gypsum scaling in the same water mixture. As can be seen, although both Water A and Water B were undersaturated (SR<1) to gypsum, the mixed water was twice as saturated (supersaturated at Water A=30%-50%). FIG. 2 also shows that a significant amount of gypsum was predicted to be formed, which can plug the pore-throat of rocks and reduce permeability of the disposal wells.

TABLE 2
Scale prediction results for gypsum under a trunkline condition

| Water A | Water B | Saturation Ratio (SR) | Scaling Amount (mg/L) |
|---|---|---|---|
| 0% | 100% | 0.85 | 0 |
| 10% | 90% | 1.47 | 1487 |
| 20% | 80% | 1.83 | 2055 |
| 30% | 70% | 2.00 | 2103 |
| 40% | 60% | 2.05 | 1942 |
| 50% | 50% | 2.01 | 1682 |
| 60% | 40% | 1.91 | 1369 |
| 70% | 30% | 1.74 | 1028 |
| 80% | 20% | 1.53 | 668 |
| 90% | 10% | 1.26 | 299 |
| 100% | 0% | 0.92 | 0 |

Calcium sulfate scale can be present in three different forms: gypsum, anhydrite, and hemi-hydrate. As shown in FIG. 3, gypsum was predicted to be the most common one observed in the oilfield, especially at temperatures <100° C.

### Example 2—Static Bottle Tests with Threshold Scale Inhibitors

Static bottle tests were performed on a mixture of Water A and Water B using a threshold scale inhibitor. The composition of the bottle test water is shown in Table 3.

TABLE 3
Bottle test water (50% Water A/50% Water B)

| Ion | (mg/L) |
|---|---|
| Sodium | 31957 |
| Potassium | 2340 |
| Magnesium | 4044 |
| Calcium | 17623 |
| Strontium | 658 |
| Bicarbonate | 426 |
| Chloride | 93280 |
| Sulfate | 1908 |

By adding a threshold scale inhibitor, such as based on organic-phosphates or polyacrylate polymers, the formation of scale often can be controlled. Two scale inhibitors, SCALETREAT 16298, a polymeric inhibitor based on 2-butanedioic acid (2Z)-polymer with sodium 2-propene-1-sulfonate (Clariant), and SCW 22127, a phosphonate product formulated with diethylenetriamine penta(methylene phosphonic acid) (Baker Hughes), were tested.

Test conditions were as follows. To the test water a 50:50 mixture of Water A and Water B (Table 3) was added either 2 ppm, 5 ppm, 10 ppm, or 25 ppm of one of the two scale inhibitors. The water was kept at 70° C. for the duration of the test. Samples were obtained and measured at 2 hours, 4 hours, and 24 hours after addition of the scale inhibitor. The formation of scale was determined by visual observation and the results are shown in Tables 4 and 5, where “No” is no scale; “PPT (T)” is trace amount of scale; and “PPT” is scale formed.

TABLE 4
Static bottle test results using SCALETREAT 16298

| Time | 2 ppm | 5 ppm | 10 ppm | 25 ppm |
|---|---|---|---|---|
| 2 hrs | PPT (T) | No | No | No |
| 4 hrs | PPT | PPT (T) | No | No |
| 24 hrs | PPT | PPT | PPT (T) | No |

TABLE 5
Static bottle test results using SCW 22127

| Time | 2 ppm | 5 ppm | 10 ppm | 25 ppm |
|---|---|---|---|---|
| 2 hrs | PPT | No | No | No |
| 4 hrs | PPT | PPT | No | No |
| 24 hrs | PPT | PPT | PPT | No |

As can be seen in Tables 4 and 5, scale formation was effectively prevented by the addition of the inhibitors. The higher the inhibitor concentration, the longer scale formation was prevented in the water. These results indicate that the calcium sulfate scale can be effectively controlled in surface facilities, such as in trunklines and separation plants (GOSPs). However, when water is injected into a disposal well, any scale inhibitor present will react with the rock and part of the inhibitor will be retained on the rock surface. Thus, the inhibitor concentration will gradually decrease as water travels in the pore space of a disposal well, as illustrated in FIG. 4. FIG. 5 is a flow chart representing the path produced water takes from the oil well to the disposal well.

### Example 3—Static Bottle Tests with Threshold Inhibitors and Barium Chloride

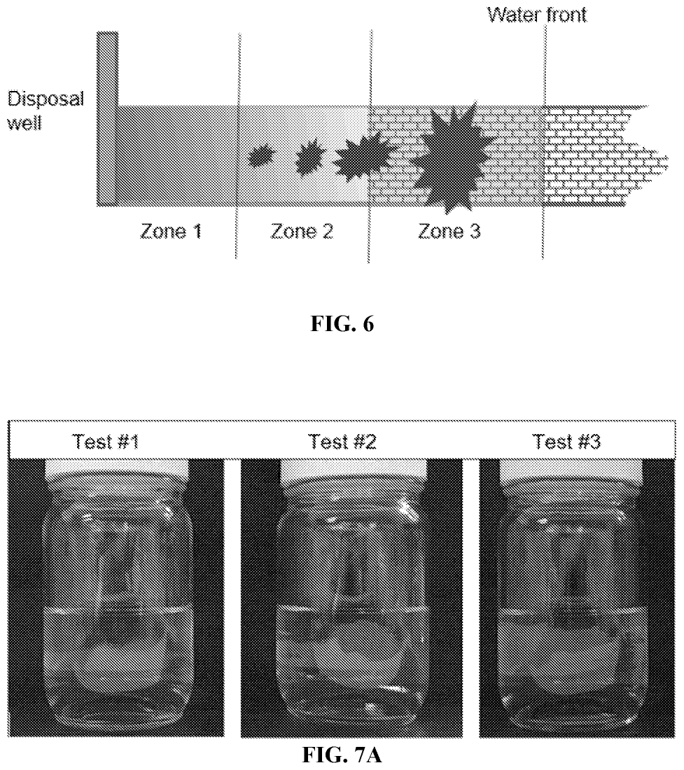

Scale inhibitor concentration can be divided into three distinct zones within a disposal well, as shown in FIG. 6. In Zone 1, scale inhibitor, although partially consumed by rocks, is sufficient to prevent calcium sulfate scale formation. In Zone 2, scale inhibitor concentration is below the minimum required dosage, and water is under-protected. Calcium sulfate scale can start to form, although the scale inhibitor present could slow down the crystal growth rate of the calcium sulfate scale. In Zone 3 there is no scale inhibitor or very low scale inhibitor present. Calcium sulfate scale will form and the growth is not affected by scale inhibitor.

The calcium sulfate scale formed in Zone 2 and Zone 3 will decrease permeability and injectivity, and may eventually plug the disposal wells from further operation. Adding high concentrations of scale inhibitor will extend the Zone 1, but does not eliminate scale formation in Zone 2 and Zone 3.

The use of soluble barium salts in addition to a scale inhibitor for scale control in disposal wells was tested. The sulfate in the produced water after GOSP (prior to injection into a disposal well) was removed by using the chemical solubility behavior of sulfate minerals. Barium sulfate has much lower solubility than calcium sulfate. At room temperature, 1 liter of water dissolves only 2.2 mg of barium sulfate (BaSO₄), but can dissolve 2090 mg of calcium sulfate in the form of anhydrite (CaSO₄) or 2410 mg in form of gypsum (CaSO₄•2H₂O). The soluble barium salts added to the water reacted with sulfate and precipitated out of water as barium sulfate. Thus, the sulfate concentration was reduced and the treated water became much less supersaturated to calcium sulfate scale. With enough sulfate removed, water will be under-saturated and the potential for calcium sulfate formation in the disposal wells is eliminated.

Tests were conducted at 50° C. with the water listed in Table 3. BaCl₂•2H₂O salt was used. 25 ppm of the scale inhibitors SCALETREAT 16298 and SCW 22127 were added to simulate the mixed water being treated with scale inhibitor in the trunkline or GOSP. The test procedure was as follows. Synthetic brines using Water A and Water B (see Table 3) were prepared and then filtered through 0.45 μm filter paper to remove suspended solids. 50 ml of Water A was transferred and placed into a pre-heated oven (50° C.). 50 mL of Water B was transferred into another test bottle and then 0.25 mL of 1% scale inhibitor stock solution was added. After 2 hrs the pre-heated bottles were mixed. After 1, 2, and 4 hours, a ˜5 mL aliquot of water was taken from the test bottle and filtered through 0.45 μm filter paper to remove solids. 1 mL of the filtered solid-free sample was pipetted into a test tube filled with 10 mL of DI water. Sulfate analysis was performed on the collected samples.

Precipitation Tests were Run on Three Different Samples, as Shown in Table 6.

TABLE 6
Scale inhibitor and barium chloride concentrations

| Test | | |
|---|---|---|
| Run # | Scale Inhibitor | Salt |
| #1 | 25 ppm SCALETREAT 16298 | 0.60 grams of BaCl₂•2H₂O |
| #2 | 25 ppm SCW 22127 | 0.45 grams of BaCl₂•2H₂O |
| #3 | 25 ppm SCALETREAT 16298 | 0.30 grams of BaCl₂•2H₂O |

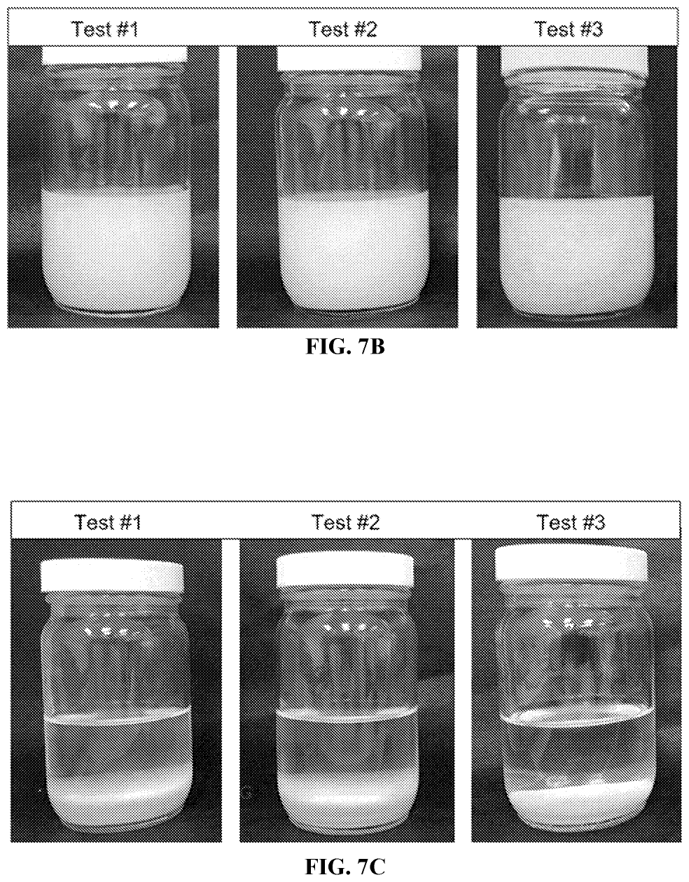

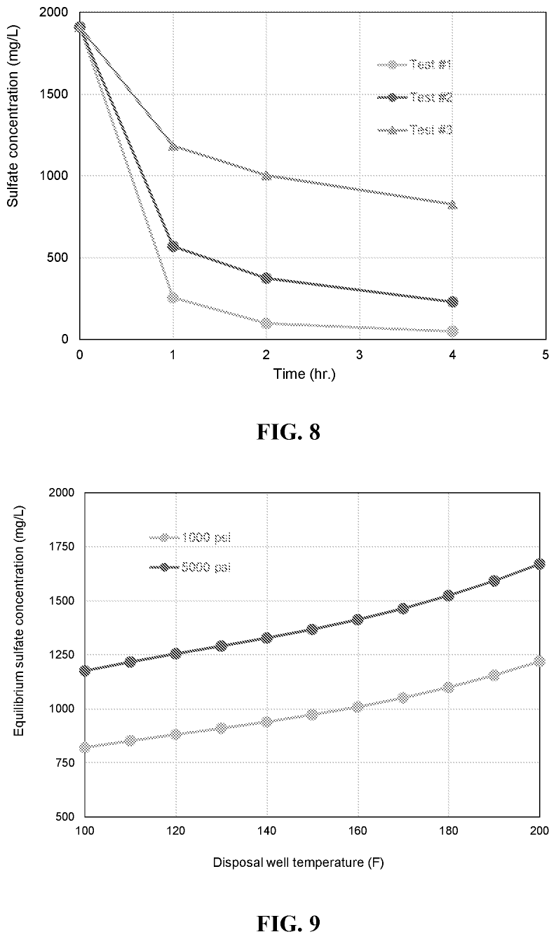

Once the barium chloride was added to the water with the scale inhibitor, the precipitation reaction occurred immediately and the water turned from clear (FIG. 7A) to milky (FIG. 7B). Under static conditions, the precipitates accumulated at the bottom of the test bottle under gravity (FIG. 7C).

The collected water samples were analyzed by ion chromatography (IC) to determine sulfate concentrations and the results are listed in Table 7 and shown in FIG. 8.

TABLE 7
Sulfate concentrations (mg/L) in treated water

| Time | #1 | #2 | #3 |
|---|---|---|---|
| Initial | 1910 mg/L | 1910 mg/L | 1910 mg/L |
| After 1 hr. | 255 mg/L | 568 mg/L | 1184 mg/L |
| After 2 hrs. | 98 mg/L | 374 mg/L | 1003 mg/L |
| After 4 hrs. | 49 mg/L | 229 mg/L | 826 mg/L |

These results show that sulfate in CaSO₄ supersaturated produced water was effectively removed by adding barium chloride. The presence of scale inhibitor, which is added to produced water to prevent CaSO₄ scale in surface facilities, had very little or no effect on sulfate reduction using the method tested. Most of the precipitation reaction occurred within the first hour after salt addition. The amount of sulfate removed depended on the type of salt added and the amount of salt added. With the addition of soluble barium salts, sulfate concentration was reduced to a very low level (<50 mg/L). The salt can be added either in solid powder form or as a concentrated solution.

The equilibrium sulfate concentration was calculated using the scale prediction model, such as ScaleSoftPitzer, under the disposal well conditions (temperature and pressure). By reducing the sulfate in produced water below this equilibrium level, no gypsum scale will be formed due to the water being under-saturated. Table 7 and FIG. 9 show the calculated equilibrium sulfate concentrations for the water depicted in Table 3 under various conditions (temperatures of 100° F.-200° F. and pressures of 1000 and 5000 psi). There is no potential for formation of calcium sulfate scale once the sulfate concentration of the water is reduced below these values.

TABLE 8
Calculated equilibrium sulfate concentrations for water in Table 3

| Temp. (° F.) | 1000 psi | 5000 psi |
|---|---|---|
| 100 | 822 | 1176 |
| 110 | 853 | 1217 |
| 120 | 882 | 1255 |
| 130 | 910 | 1291 |
| 140 | 940 | 1328 |
| 150 | 973 | 1368 |
| 160 | 1009 | 1413 |
| 170 | 1051 | 1464 |
| 180 | 1100 | 1524 |
| 190 | 1156 | 1592 |
| 200 | 1220 | 1670 |

Reducing the sulfate concentration in produced water can be achieved by either treating the full stream or the partial stream (FIG. 9). In treating the full stream, the amount of barium sulfate is calculated based on the equilibrium sulfate concentration. When the water flow rate is high, it could be more economical to treat a side-stream to achieve very low sulfate concentration, then mixed with the untreated streams. For example, to achieve the sulfate concentration ≤1170 mg/L in water listed in Table 3, 40% water can be treated to have sulfate reduced to <50 mg/L (Test #1 in Table 6 after 4 hrs), then mixed with the 60% untreated scaling water (sulfate=1910 mg/L) to achieve a final sulfate concentration of 1166 mg/L (=49*40%+1910*60%). When this mixed water is injected into the disposal wells with temperatures of 100ºF and 5000 psi, it is under-saturated to gypsum and, therefore, no gypsum scale will be formed in the disposal well reservoir.

What is claimed is:

1. A method for reducing or preventing mineral scale formation in a well, comprising:
treating a water source supersaturated with calcium sulfate with a water-soluble barium salt, wherein the water-soluble barium salt reacts with the calcium sulfate to form a barium sulfate solid in the treated water source;
providing the treated water source to a well; and
reducing or preventing mineral scale formation in the well.

2. The method of claim 1, wherein the water-soluble barium salt is selected from the group consisting of barium acetate, barium chloride, barium cyanide, barium hydroxide, and barium oxide.

3. The method of claim 2, wherein the water-soluble barium salt is barium chloride.

4. The method of claim 1, wherein the water source comprises fresh water, pond water, sea water, produced water, tower water, or a combination thereof, and is used in oil and gas recovery operations.

5. The method of claim 4, wherein the water source is produced water.

6. The method of claim 1, wherein the well is a disposal well.

7. The method of claim 1, wherein the water source supersaturated with calcium sulfate comprises a sulfate concentration that is greater than the equilibrium sulfate concentration.

8. The method of claim 1, wherein the treated water source comprises a sulfate concentration that is lower than the equilibrium sulfate concentration.

9. The method of claim 1, wherein the amount of water-soluble barium salt is sufficient to yield a barium concentration that is at least about 50% higher than the sulfate concentration in the water source.

10. The method of claim 1, wherein the amount of water-soluble barium salt added to the water source supersaturated with calcium sulfate is about 50% greater than the amount of sulfate in the water source.

11. The method of claim 1, wherein the barium sulfate solid is removed from the treated water source prior to providing the treated water source to the well.

12. The method of claim 11, wherein the barium sulfate solid is removed by gravitational sedimentation, medium filtration, bag filtration, a centrifugal separator, or a cyclone separator.

13. The method of claim 1, wherein the water source supersaturated with calcium sulfate comprises a scale inhibitor.

14. The method of claim 1, wherein the treated water source is mixed with an untreated water source supersaturated with calcium sulfate prior to providing the treated water source to the well, wherein the mixture comprises a sulfate concentration that is lower than the equilibrium sulfate concentration.

15. A method for decreasing the sulfate concentration in water produced during oil and gas recovery, comprising:
treating the produced water with a water-soluble barium salt, wherein the produced water is supersaturated with calcium sulfate;
reacting the calcium sulfate with the water-soluble barium salt to form a barium sulfate solid; and
removing the barium sulfate solid from the treated water, wherein the treated water is undersaturated in calcium sulfate after removal of the barium sulfate solid.

16. The method of claim 15, wherein the water-soluble barium salt is selected from the group consisting of barium acetate, barium chloride, barium cyanide, barium hydroxide, and barium oxide.

17. The method of claim 16, wherein the water-soluble barium salt is barium chloride.

18. The method of claim 15, wherein the barium sulfate solid is removed by gravitational sedimentation, medium filtration, bag filtration, a centrifugal separator, or a cyclone separator.

19. The method of claim 15, further comprising providing the water undersaturated in calcium sulfate to a well.

20. The method of claim 19, wherein the well is a disposal well.

21. The method of claim 15, wherein the produced water comprises a scale inhibitor.
